(19) United States
(12) Patent Application Publication
(10) Pub. No.: US 2006/0009297 A1
(43) Pub. Date: Jan. 12, 2006

(54) Flexible coupling having a center with opposing re-entrant folds

(76) Inventors: William R. Hubiak, West Allis, WI (US); Duane V. Byerly, Lincoln, NE (US); William E. Ryan, Sussex, WI (US); Gordon W. Craig, Woodlands, TX (US)

Correspondence Address: QUARLES & BRADY LLP, 411 E. WISCONSIN AVENUE, SUITE 2040, MILWAUKEE, WI, 53202-4497, US

(21) Appl. No.: 10/887,051

(22) Filed: Jul. 8, 2004

(51) Int. Cl. F16D 3/52

(52) U.S. Cl. 464/88

(57) ABSTRACT

A coupling for transmitting torque between two shafts approximately aligned on a shaft axis, and a method of making the coupling. The coupling can accommodate axial, lateral, and angular shaft misalignments without the problems associated with prior art couplings includes an arcuate flexible center element having two axially spaced radially extending leg portions joined by an axially extending bridging portion. The axially extending bridging portion has at least two opposing re-entrant folds defining a T-shaped cross-section in a radial plane extending from and along the shaft axis.

### CROSS REFERENCES TO RELATED APPLICATIONS

Not Applicable

### STATEMENT REGARDING FEDERALLY SPONSORED RESEARCH

Not Applicable

### BACKGROUND OF THE INVENTION

This invention relates to flexible shaft couplings, and more particularly, to composite flexible couplings for transmitting torque between two shafts approximately aligned on a shaft axis, i.e., to flexible couplings joining a pair of axially spaced shafts. Flexible diaphragm couplings comprising a pair of shoes joined by a generally U-shaped flexible center element, such as disclosed in U.S. Pat. Nos. 4,634,400; 6,080,065; 6,117,015; 6,196,926; and 6,257,985, all issued to the assignee of the present application, can accommodate axial misalignments (i.e. the spacing between the shafts is not optimum per coupling design) and angular misalignments (i.e. the shaft axes intersect at a point) without large stresses by using a bellows actions. U.S. Pat. Nos. 4,634,400; 6,080,065; 6,117,015; 6,196,926; and 6,257,985 are all fully incorporated herein by reference.

These known couplings, however, have difficulty accommodating lateral misalignment (i.e. the shaft axes do not intersect and are not coaxial). One known method for coupling laterally misaligned shafts is to provide a flexible diaphragm coupling having an oversized flexible center element that can accommodate the bellows action in orthogonal directions. Unfortunately, the oversized flexible center element increases the coupling mass which increases the loads and forces on the hub attachment assembly. Moreover, the large flexible element can decrease the torsional stiffness of the coupling and increase wind up deformation. Accordingly, a need exists for an improved coupling which can accommodate axial, lateral, and angular shaft misalignments.

### SUMMARY OF THE INVENTION

The present invention provides a flexible coupling for transmitting torque between two shafts approximately aligned on a shaft axis, and a method of making the novel coupling. The coupling can accommodate axial, lateral, and angular shaft misalignments without the problems associated with prior art couplings. One embodiment of a flexible coupling incorporating the present invention includes an arcuate flexible center element having two axially spaced radially extending leg portions joined by an axially extending bridging portion. The axially extending bridging portion has at least two opposing re-entrant folds defining a T-shaped cross-section in a radial plane extending from and along the shaft axis.

A general objective of the present invention is to provide a flexible coupling that can accommodate axial, lateral, and angular shaft misalignments without the problems associated with prior art diaphragm couplings. This objective is accomplished by providing a coupling having a center element including a bridging portion with at least two opposing re-entrant folds defining a T-shaped cross-section in a radial plane extending from and along the shaft axis.

The foregoing and other objects and advantages of the invention will appear from the following description. In the description, reference is made to the accompanying drawings which form a part hereof, and in which there is shown by way of illustration a preferred embodiment of the invention.

### BRIEF DESCRIPTION OF THE DRAWINGS

FIG. 1 is a perspective view of one embodiment of a portion of a coupling incorporating various of the features of the invention, which view is taken from the inside of the coupling;

FIG. 2 is an elevational view of the inside of the couplings shown in FIG. 1;

FIG. 3 is a partially broken away and sectioned axial side view of the entire coupling shown in FIG. 1, with one half thereof shown in dotted outline;

FIG. 4 is a perspective view of the center element of FIG. 1;

FIG. 5 is a fragmentary view of a second embodiment of a coupling incorporating various of the features of the invention;

FIG. 6 is a perspective view of a third embodiment of a portion of a coupling incorporating various of the features of the invention, which view is taken from the inside of the coupling;

FIG. 7 is an elevational view of the inside of the couplings shown in FIG. 6;

FIG. 8 is a partially broken away and sectioned axial side view of the entire coupling shown in FIG. 6, with one half thereof shown in dotted outline; and

FIG. 9 is a cross-sectional axial side view of the coupling shown in FIG. 6 in a mold during manufacture.

Before one embodiment of the invention is explained in detail, it is to be understood that the invention is not limited in its application to the details of the construction and the arrangements of components set forth in the following description or illustrated in the drawings. The invention is capable of other embodiments and of being practiced or being carried out in various ways. Also, it is understood that the phraseology and terminology used herein is for the purpose of description and should not be regarded as limiting.

### DESCRIPTION OF THE PREFERRED EMBODIMENT

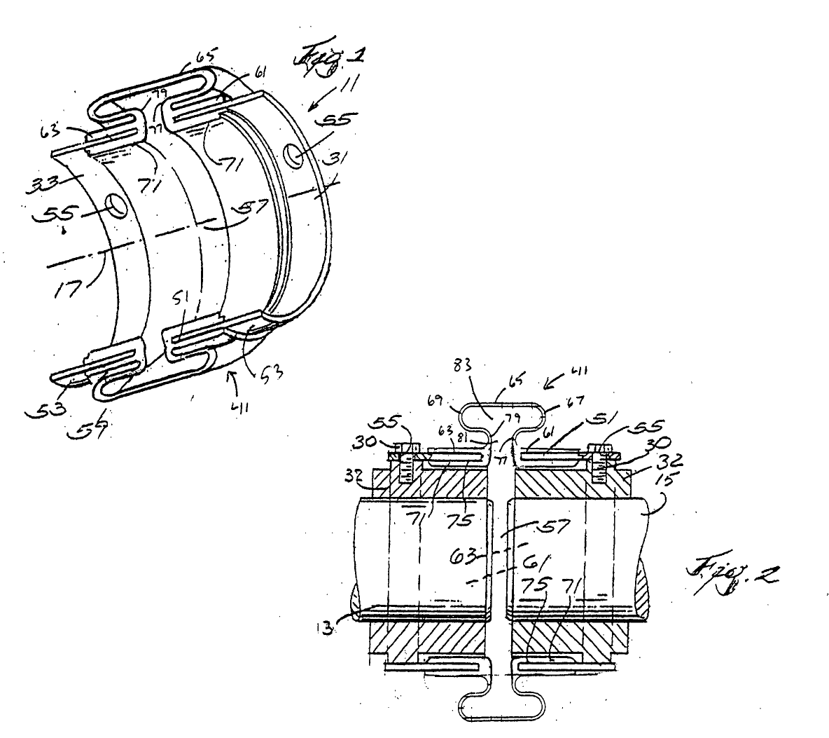

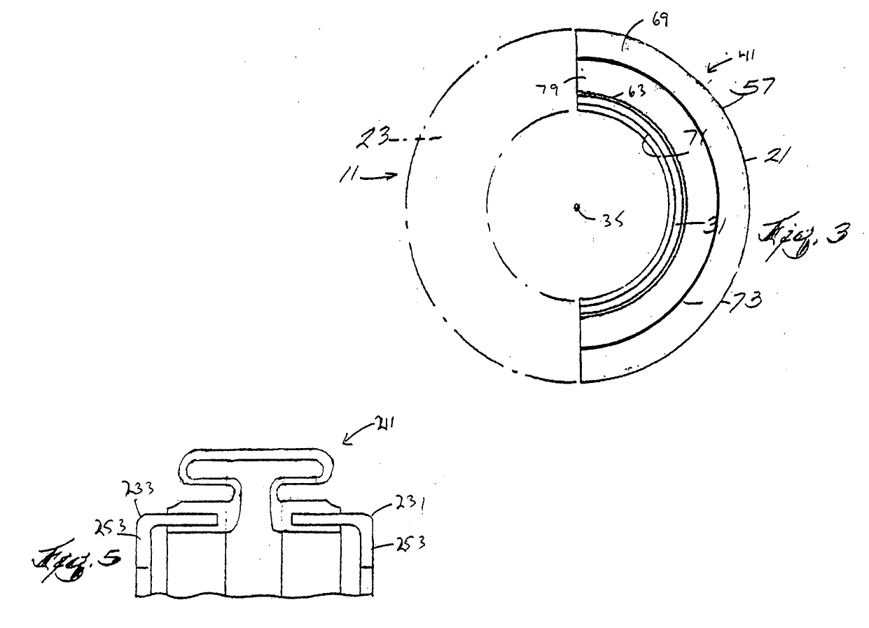

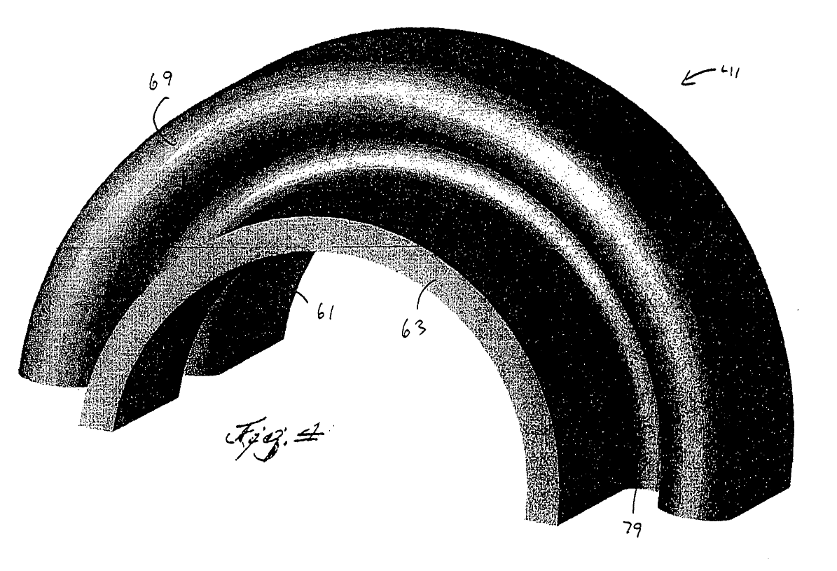

A composite flexible diaphragm coupling 11 for transmitting torque between first and second axially spaced and oppositely extending shafts 13 and 15 which are approximately aligned on a shaft axis 17 is shown in FIG. 1-3. The coupling 11 comprises first and second angularly spaced composite flexible arcuate members 21 and 23 (FIG. 3) which are of generally identical construction, and respectively extend for approximately 180 degrees around a coupling axis 35. The arcuate members include first and second oppositely extending arcuate shoes 31 and 33 which are joined by an arcuate flexible T-shaped center element 41.

Because the first and second composite members 21 and 23 are generally identically constructed, only the first composite member 21 will be described in detail. More specifically, the first and second shoes 31 and 33 are also of generally identical construction and each arcuately extends for an arcuate distance which can be almost 180 degrees. In addition, the first and second shoes 31 and 33 extend axially in opposite directions to each other. More particularly, the first and second shoes 31 and 33 each include an inner part 51 which is bonded to the central element 41, and an outer part 53 which extends from the inner part 51 and which is adapted, in any suitable way, to be connected to an associated one of the oppositely extending shafts 13 and 15. In the particularly illustrated construction, the outer parts 53 each include one or more apertures 55 which permit the shoes 31 and 33 to be fixed by bolts 30 to generally cylindrical hubs 32. The hubs 32 include central bores 34 housing the shafts 13 and 15.

The shoes 31 and 33 can take any number of suitable configurations and, in the disclosed construction, the inner and outer parts 51 and 53 are preferably of generally semi-cylindrical configuration. In addition, the shoes 31 and 33 can be fabricated of any suitable metallic or plastic material and, in the disclosed construction, are preferably fabricated of suitable plastic material.

The center element 41 is formed from a composite sheet material, and includes first and second leg portions 61 and 63 which are generally identically constructed and which are axially spaced from each other and joined by a bridging portion 65. The sheet material is preferably a glass fiber fabric impregnated with a vinyl ester resin, however any flexible material, such as a urethane material, can be used without departing from the scope of the invention. The leg portions 61, 63 and bridging portion 65 extend arcuately for an arcuate distance which is approximately 180 degrees.

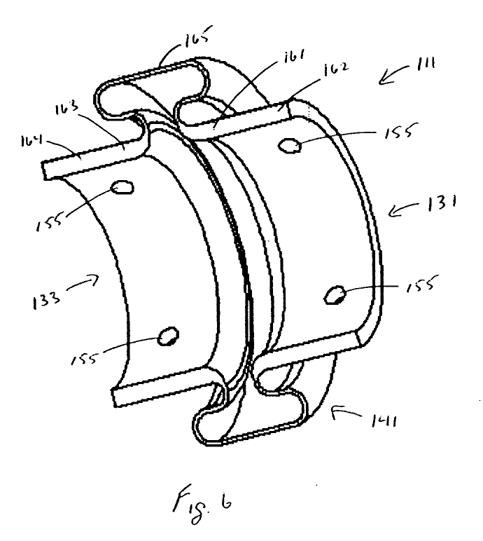

Referring to FIGS. 1-4, the bridging portion 65 includes a pair of centrally located, opposing, outward, re-entrant folds 67, 69. Each fold 67, 69 is joined to one of the leg portions 61, 63 by a radially extending base portion 77, 79 to define a generally T-shaped cross-section in a radial plane extending from and along the shaft axis 17 or coupling axis 35, wherein the T-shaped cross-section has a radially extending stem 81 with a top 83 substantially perpendicular to the stem 81. Although only one pair of opposing, outward, re-entrant folds is shown, more than one pair of opposing, outward, re-entrant folds can be provided without departing from the scope of the invention.

Advantageously, the bridging portion 65 including at least one pair of centrally located, opposing, outward, re-entrant folds 67, 69 which defines the T-shaped cross-section accommodates axial, lateral, and angular misalignments without the accompanying increase of coupling mass, loads and forces on the shafts, and wind up deformation, associated with prior art U-shaped cross-section center elements. Moreover, the center element 41 including the bridging portion 65 having the T-shaped cross-section provides a coupling with a diameter that is smaller than a prior art coupling sized for the same torque loads and misalignments.

The leg portions 61 and 63 each include a radially inner part 71 bonded to the cylindrical portion of the associated one of the shoes 31 and 33. The inner parts 71, respectively, include oppositely facing, arcuately extending recesses 75 which receive, and are bonded to, the inner parts 51 of the associated shoes 31 and 33. Any suitable method for bonding the shoes 31 and 33 to the inner parts 71 can be employed.

FIG. 5 is another embodiment of a coupling 211 which is of generally the same construction as that shown in FIGS. 1-3, except that the outer parts 253 of the shoes 231, 233 extend radially for engaging the shafts 13, 15 or hub 32.

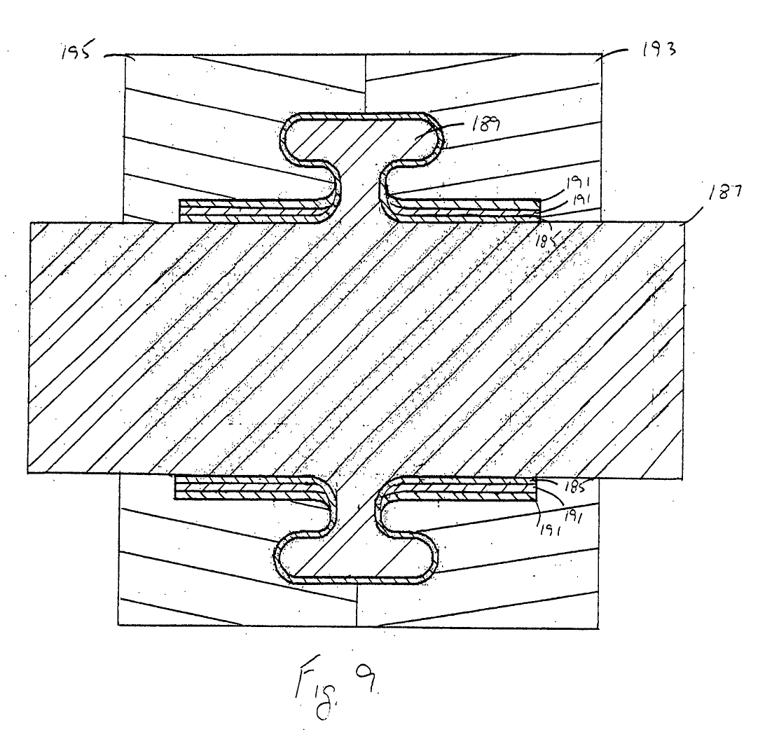

In FIG. 6-8, a preferred embodiment of a flexible diaphragm coupling 111 for transmitting torque between first and second axially spaced and oppositely extending shafts 113 and 115 which are approximately aligned on a shaft axis 117 is shown. The coupling 111 comprises first and second angularly spaced flexible arcuate members 121 and 123 (FIG. 8) which are of generally identical construction, and respectively extend for approximately 180 degrees around a coupling axis 135.

Each arcuate members 121, 123 is preferably formed from a suitable material as a single piece. The material is preferably a glass fiber fabric impregnated with a vinyl ester resin, however, as in the above described embodiments, any flexible material, such as polyether urethane, can be used without departing from the scope of the invention. Because the first and second arcuate members 121 and 123 are generally identically constructed, only the first arcuate member 121 will be described in detail.

The arcuate member 121 including an arcuate flexible T-shaped center element 141 having integral shoes 131, 133. The T-shaped center element 141 includes first and second leg portions 161, 163 joined by a bridging portion 165. The bridging portion 165 includes a pair of centrally located, opposing, outward, re-entrant folds 167, 169. Each fold 167, 169 is joined to one of the leg portions 161, 163 by a radially extending base portion 177, 179 to define a generally T-shaped cross-section in a radial plane extending from and along the shaft axis 117, wherein the T-shape has a radially extending stem 181 with a top 183 substantially perpendicular to the stem 181. As in the first embodiment, although only one pair of opposing, outward, re-entrant folds is shown, more than one pair of opposing, outward, re-entrant folds can be provided without departing from the scope of the invention.

Advantageously, as in the first embodiment, the T-shaped cross-section accommodates axial, lateral, and angular misalignments without the accompanying increase of coupling mass, loads and forces on the shafts, and wind up deformation, associated with prior art U-shaped cross-section center elements. Moreover, the center element 141 including the bridging portion 165 having the T-shaped cross-section provides a coupling with a diameter that is smaller than a prior art coupling sized for the same torque loads and misalignments.

The first and second leg portions 161, 163 extend in axially opposite directions from the bridging portion 165. Outer parts 162, 164 of the first and second leg portions 161, 163 form the integral shoes 131, 133 formed of the same material as the center element 141. The shoes 131, 133 are generally identically constructed and axially spaced from each other. Preferably, the shoes 131, 133 have a material thickness greater than the thickness of the material forming the bridging portion 165 to increase the shear strength of each shoe 131, 133. The additional thickness can be formed by applying additional material forming the shoes 131, 133 over the outer parts 162, 164 of the first and second leg portions 161, 163, or a different material, such as metal, an elastomer, and the like, can be embedded in, bonded to, or mechanically fastened to, to the outer parts 162, 164 of the first and second leg portions 161, 163 forming the shoe 131, 133.

Apertures 155 formed through shoes 131 and 133 receive bolts 130 which fix the coupling 111 to the shafts 113, 115. The bolts 130 pass through the apertures 155 and threadably engage hubs 132 fixed to the shafts 113, 115 to fix the coupling 111 to the shafts 113, 115. Of course, other methods for fixing the coupling to the shafts can be used, such as pinning (i.e. using pins extending through the coupling into the shafts), bonding (i.e. adhesives and other chemical fasteners), mechanically interlocking the coupling with the shafts, and the like, without departing from the scope of the invention. Grommets can be fixed in the apertures 155 to strengthen the aperture peripheries.

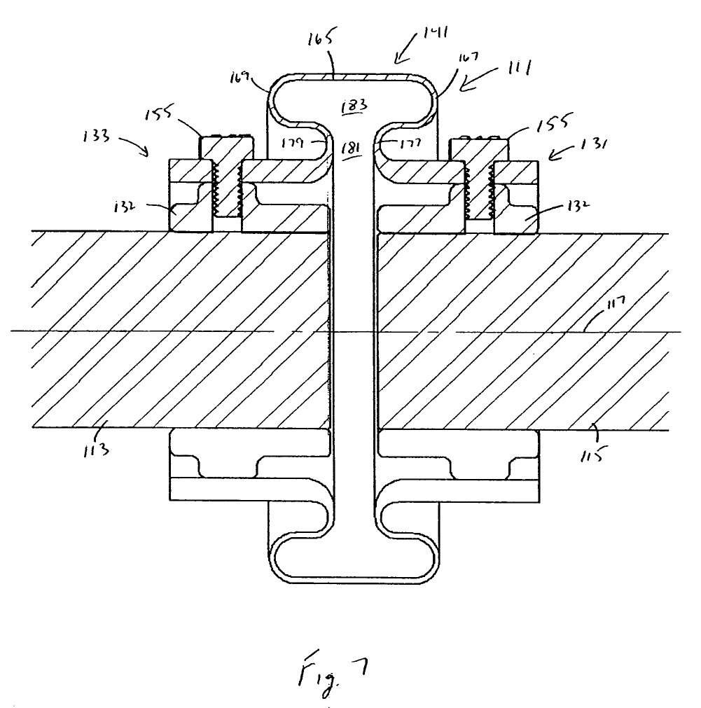

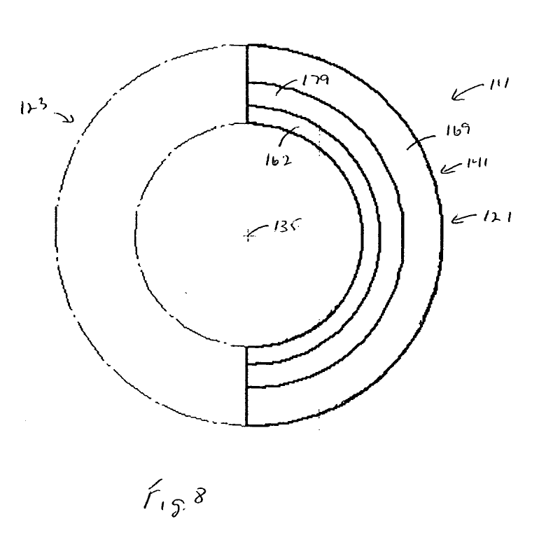

Referring now to FIGS. 7 and 9, the coupling 111 is preferably made by a resin transfer molding process. In particular, in a preferred method of making the coupling 111, the coupling 111 is formed by slipping a cylindrical sleeve 185 or laying a sheet of glass fiber fabric over a cylindrical mandrel 187 having a radially extending T-shaped form 189. Although a cylindrical sleeve of glass fiber fabric is preferred, the sheet material can be formed by winding fibers around the mandrel without departing from the scope of the invention. Advantageously, the cylindrical sleeve 185 conforms to the shape of the mandrel 187 including the radially extending T-shaped form 189. Additional layers 191 of the same or different material, such as additional cylindrical sleeves of fabric, sheets of fabric, fiber windings, metal rings, and the like can be placed over the sleeve 185 on opposite axial sides of the T-shaped form 189 to build up the integral shoes 131, 133, such that the shoes 131, 133 are more rigid than the center element 141 for withstanding the shear forces exerted on the shoes 131, 133 by the shafts 113, 115. Of course, additional material can also be applied over the T-shaped form 189 to increase the thickness of the center element 141, if desired.

Once the material forming the coupling is applied onto the mandrel 187, molds 193, 195 axially slipped onto the mandrel 187 from opposing sides of the T-shape form 189 encloses the material applied to the mandrel 187 and T-shaped form 189, and urges the material to conform to the shape of the mandrel 187 and T-shape form 189. Resin, such as a vinyl ester resin, is injected into the mold to impregnate the glass fiber material and any other impregnable material forming part of the coupling 111, as is known in the art. The resin impregnated material is then cured, and cut axially along a plane intersecting the coupling axis to form the two arcuate members 121, 123. Advantageously, the center element 141 wrapped around the T-shaped form 189 is flexible to allow the removal of the arcuate members 121, 123 from the mandrel 187 and T-shaped form 189. Of course, the above method can used to make the flexible center element 41 of the first embodiments shown in FIGS. 1-5, and the shoes can be fixed to the center element during the application of the material to the mandrel, upon curing, or subsequent to removal of the center element from the mandrel.

While there has been shown and described what are at present considered the preferred embodiment of the invention, it will be obvious to those skilled in the art that various changes and modifications can be made therein without departing from the scope of the invention defined by the appended claims. Therefore, various alternatives and embodiments are contemplated as being within the scope of the following claims particularly pointing out and distinctly claiming the subject matter regarded as the invention.

We claim:

1. A coupling for transmitting torque between two shafts approximately aligned on a shaft axis, said coupling comprising:
an arcuate flexible center element having two axially spaced radially extending leg portions joined by an axially extending bridging portion, said axially extending bridging portion having at least two opposing re-entrant folds defining a T-shaped cross-section in a radial plane extending from and along said shaft axis.

2. The coupling as in claim 1, in which a shoe is joined to at least one of said leg portions and is fixable relative to one of said shafts.

3. The coupling as in claim 2, in which said shoe is formed as an integral part of said at least one of said leg portions.

4. The coupling as in claim 2, in which said shoe has a first portion and a second portion extending from said first portion, and said first portion is bonded to said at least one of said leg portions.

5. The coupling as in claim 2, in which said at least one of said leg portions includes an arcuate recess receiving said first portion of said shoe.

6. The coupling as in claim 2, in which said shoe includes a material selected from a group consisting of plastic, metal, urethane, and resin impregnated fiber.

7. The coupling as in claim 1, in which each of two of said at least two opposing re-entrant folds is joined to a different one of said leg portions by radially extending base portions defining a stem of said T-shaped cross-section.

8. The coupling as in claim 1, in which said center element includes a material selected from a group consisting of plastic, urethane, and resin impregnated fiber.

9. The coupling as in claim 1, in which said center element is semi-annular.

10. A coupling for transmitting torque between two shafts approximately aligned on a shaft axis, said coupling comprising:
an arcuately extending member including an arcuately extending shoe having an arcuately extending first portion and a second portion extending from said arcuately extending first portion and adapted to be connected to one of said shafts: and
an arcuately extending, flexible center element having two axially spaced radially extending leg portions joined by an axially extending bridging portion, at lease one of said leg portions including an inner part joined to said first portion of said shoe, said axially extending bridging portion having at least two opposing re-entrant folds defining a T-shaped cross-section in a radial plane extending from and along said shaft axis.

11. The coupling as in claim 10, in which each of two of said at least two opposing re-entrant folds is joined to a different one of said leg portions by radially extending base portions defining a stem of said T-shaped cross-section.

12. The coupling as in claim 10, in which said shoe is formed as an integral part of said at least one of said leg portions.

13. The coupling as in claim 10, in which said shoe has a first portion and a second portion extending from said first portion, and said first portion is bonded to said at least one of said leg portions.

14. The coupling as in claim 10, in which said at least one of said leg portions includes an arcuate recess receiving said first portion of said shoe.

15. The coupling as in claim 10, in which said shoe includes a material selected from a group consisting of plastic, metal, urethane, and resin impregnated fiber.

16. The coupling as in claim 10, in which each of two of said at least two opposing re-entrant folds is joined to a different one of said leg portions by radially extending base portions defining a stem of said T-shaped cross-section.

17. The coupling as in claim 10, in which said center element includes a material selected from a group consisting of plastic, urethane, and resin impregnated fiber.

18. A method of making a coupling, said method comprising:
applying a first material around a cylindrical mandrel having an axis, said mandrel including a radially extending form defining a T-shaped cross-section in a radial plane extending from and along said cylindrical mandrel axis;
enclosing said first material on the mandrel and T-shape with a mold;
urging said first material to conform to the shape of the mandrel and T-shape form;
fixing said first material in the shape of the mandrel and T-shape form to form at least a portion of said coupling having a bridging portion having at least two opposing re-entrant folds defining a T-shaped cross-section in a radial plane extending from and along said cylindrical mandrel axis; and
removing said at least a portion of said coupling from said mandrel.

19. The method as in claim 18, in which fixing said first material in the shape of the mandrel and T-shape form includes impregnating at least said first material enclosed in said mold with a resin to form a resin impregnated material and curing said resin.

20. The method as in claim 18, including applying at least one additional layer of material around said cylindrical mandrel on opposing axial sides of the T-shape form.

21. The method as in claim 20, in which said at least one additional material is the same material as said first material.

22. The method as in claim 18, in which said first material is selected from a group consisting of plastic, urethane, and resin impregnable fiber.

23. The method as in claim 18, in which said at least a portion of said coupling is removed from said mandrel by cutting said at least portion of said coupling along a plane intersecting said an axis of said coupling to form a pair of arcuate members.

24. The method as in claim 23, in which at least one shoe is bonded to an axially extending portion of at least one of said arcuate members.

25. A coupling for transmitting torque between two shafts approximately aligned on a shaft axis, said coupling comprising:
a first semi-annular member including a first semi-annular shoe having a cylindrical portion, and an outer portion extending from said cylindrical portion of said first shoe of said first member and adapted to be connected to one of said shafts, a second semi-annular shoe spaced axially from said first shoe of said first member and having a cylindrical portion extending toward said cylindrical portion of said first shoe of said first member, and an outer portion extending from said cylindrical portion of said second shoe of said first member and adapted to be connected to the other one of said shafts;
a semi-annular flexible center element located between said first and second shoes of said first member and having a first radially extending leg portion including an inner part joined to said cylindrical portion of said first shoe of said first member, and an outer part extending from said inner part of said first leg portion of said center element of said first member, a second radially extending leg portion located in spaced axial relation to said first leg portion of said center element of said first member and including an inner part joined to said cylindrical portion of said second shoe of said first member, and an outer part extending from said inner part of said second leg portion of said center element of said first member, and an axially extending bridging portion joining said outer parts of said first and second leg portions of said center element of said first member, said bridging portion of said first member having at least two opposing re-entrant folds defining a T-shaped cross-section in a radial plane extending from and along said shaft axis;
a second semi-annular member including a first semi-annular shoe having a cylindrical portion, and an outer portion extending from said cylindrical portion of said first shoe of said second member and adapted to be connected to one of said shafts, a second semiannular shoe spaced axially from said first shoe of said second member and having a cylindrical portion extending toward said cylindrical portion of said first shoe of said second member, and an outer portion extending from said cylindrical portion of said second shoe of said second member and adapted to be connected to the other one of said shafts; and
a semi-annular flexible center element located between said first and second shoes of said second member and having a first radially extending leg portion including an inner part joined to said cylindrical portion of said first shoe of said second member, and an outer part extending from said inner part of said first leg portion of said center element of said second member, a second radially extending leg portion located in spaced axial relation to said first leg portion of said center element of said second member and including an inner part joined to said cylindrical portion of said second shoe of said second member, and an outer part extending from said inner part of said second leg portion of said center element of said second member, and an axially extending bridging portion joining said outer parts of said first and second leg portions of said center element of said second member, said bridging portion of said second member having at least two opposing re-entrant folds defining a T-shaped cross-section in a radial plane extending from and along said shaft axis.

26. The coupling as in claim 25, in which each of two of said at least two opposing re-entrant folds of said bridging portion of said first element is joined to a different one of said leg portions of said first element by radially extending base portions defining a stem of said T-shaped cross-section of said first element bridging portion, and each of two of said at least two opposing re-entrant folds of said bridging portion of said second element is joined to a different one of said leg portions of said second element by radially extending base portions defining a stem of said T-shaped cross-section of said second element bridging portion.

27. The coupling as in claim 25, in which said first and second shoes of said first member is formed as an integral part of said center element located between said first and second shoes.

28. The coupling as in claim 25, in which said first and second shoes of said first member is joined to said center element located between said first and second shoes by bonding.

29. The coupling as in claim 25, in which said first and second shoes of said first member includes a material selected from a group consisting of plastic, metal, urethane, and resin impregnated fiber.

30. The coupling as in claim 25, in which said center element located between said first and second shoes includes a material selected from a group consisting of plastic, urethane, and resin impregnated fiber.
